(19) United States
(12) Patent Application Publication
(10) Pub. No.: US 2012/0075409 A1
(43) Pub. Date: Mar. 29, 2012

(54) IMAGE SEGMENTATION SYSTEM AND METHOD THEREOF

(75) Inventor: MING-CHIH HSIEH, Tu-Cheng (TW)

(73) Assignee: HON HAI PRECISION INDUSTRY CO., LTD., Tu-Cheng (TW)

(21) Appl. No.: 12/963,816

(22) Filed: Dec. 9, 2010

(30) Foreign Application Priority Data
Sep. 27, 2010 (TW) 99132535

(51) Int. Cl. H04N 7/00; G06K 9/34

(52) U.S. Cl. 348/36; 382/173; 348/E07.001

(57) ABSTRACT

An image segmentation system includes an image recording unit, an image processing unit and an image monitoring unit. The image recording unit obtains a panoramic image of a target area, and the image processing unit receives and processing image data from the image recording unit. The image processing unit divides the panoramic image into corresponding sub-images, and the sub-images are stored in the image monitoring unit.

### BACKGROUND

1. Technical Field

The disclosure generally relates to image capture, and more particularly relates to an image segmentation system used in an internet protocol (IP) camera and an image segmentation method thereof.

2. Description of the Related Art

Closed circuit television (CCTV) cameras can capture both video and still images and recordings for surveillance purposes. For example, at least four CCTV cameras located at an intersection can be electrically connected to a four-channel or nine-channel digital video recorder (DVR) to store and real-time display the images or recordings.

However, for the purpose of broadening target area and obtaining more monitoring data, a number of CCTV cameras may be equipped and used to electrically connect the DVR for comprehensive surveillance, resulting in increased design and maintenance costs.

Therefore, there is room for improvement within the art.

### BRIEF DESCRIPTION OF THE DRAWINGS

Many aspects of an exemplary image segmentation system and method thereof can be better understood with reference to the following drawings. The components in the drawings are not necessarily drawn to scale, the emphasis instead being placed upon clearly illustrating the principles of the exemplary image segmentation system and method thereof. Moreover, in the drawings, like reference numerals designate corresponding parts throughout the several views. Wherever possible, the same reference numbers are used throughout the drawings to refer to the same or like elements of an embodiment.

FIG. 1 is a block view of an image segmentation system, according to an exemplary embodiment.

FIG. 2 is a schematic view illustrating a circular image segmented into four corresponding sub-images according to the image segmentation system shown in FIG. 1.

FIG. 3 is a flowchart illustrating an image segmentation method, according to an exemplary embodiment.

### DETAILED DESCRIPTION

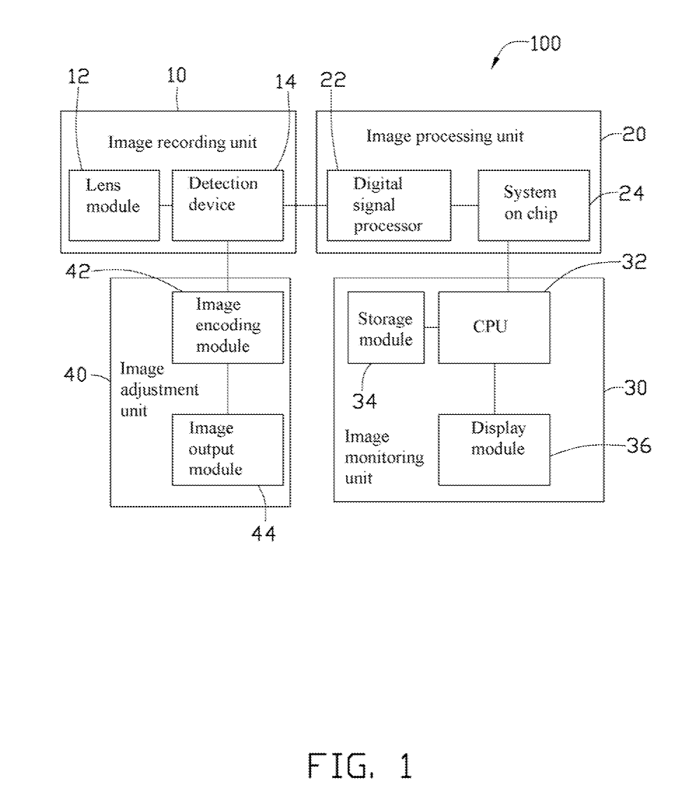

FIG. 1 shows an exemplary embodiment of an image segmentation system 100 used to monitor intersections, squares, or other areas. The image segmentation system 100 includes an image recording unit 10, an image processing unit 20, an image monitoring unit 30, and an image adjustment unit 40. The image adjustment unit 40, the image recording unit 10, the image processing unit 20 and the image monitoring unit 30 are electrically connected in series.

The image recording unit 10 and the image processing unit 20 can be integrated within an internet protocol (IP) camera (not shown). The image recording unit 10 includes a lens module 12 and a detection device 14 electrically connected to the lens module 12.

The lens module 12 obtains and captures 360° panoramic images, and transmits the panoramic images to the detection device 14. The detection device 14 receives the panoramic images and converts the received optical panoramic images into corresponding digital signals, which are accordingly transmitted to the image processing unit 20 and the image adjustment unit 40. In this exemplary embodiment, the lens module 12 can be a fisheye lens, providing a wide visual angle and short focal length, and can capture round and/or circular images. The detection device 14 can be a complementary metal oxide semiconductor (CMOS) sensor.

The image processing unit 20 receives and processes digital signals from the detection device 14 and includes a digital signal processor (DSP) 22 and a system on chip (SOC) 24 electrically connected to the DSP 22. The DSP 22 is electrically connected to the detection device 14 and receives the digital signals for processing such as segmenting, expanding, and correcting, providing segmented panoramic images into multi-channel, such as four-channel and nine-channel sub-image signals.

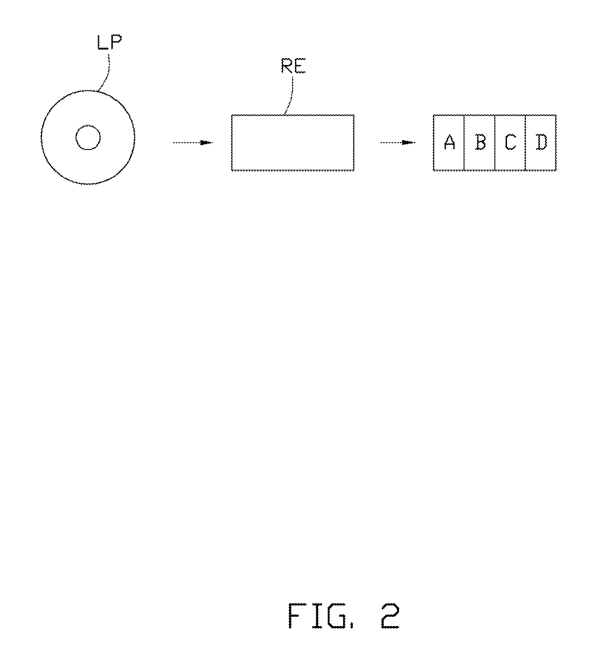

Further referring to FIG. 2, for example, a circular image LP is captured and provided by the lens module 12, and then is transmitted from the detection device 14 to the DSP 22. The DSP 22 segments the circular image LP along any radial direction, and expands the segmented image to generate a corresponding sectorial image. The DSP 22 then corrects and strengthens the sectorial image so that the inner side is equal to the outer side, further generating a corresponding rectangular image RE. Accordingly, the DSP 22 further segments rectangular image RE, as to divide the rectangular image RE into four equal or substantially equal sub-images A, B, C and D. Thus, the segmented four-channel sub-images A, B, C and D can respectively show and monitor the intersection in four directions.

The SOC 24 receives the multi-channel sub-image signals from the DSP 22, and compresses the sub-image signals to reduce redundant data and improve transmission speed. The SOC 24 can be integrated with different extended interfaces, such as memory extended interfaces, touch panel extended interfaces, and/or universal serial bus (USB) interfaces.

The image monitoring unit 30 includes a central processing unit (CPU) 32, a storage module 34, and a display module 36. The CPU 32 is electrically connected to the storage module 34 and the display module 36. The CPU 32 and the storage module 34 can be integrated within a digital video recorder (DVR) (not shown). The CPU 32 is electrically connected to SOC 24 to receive the compressed sub-image signals. The compressed sub-image signals are then stored into the storage module 34 under the control of the CPU 32, or are transmitted to the display module 36 through the Ethernet.

The display module 36 displays the multi-channel sub-images to monitor conditions of the target areas in real time. In this exemplary embodiment, the storage module 34 can be a hard disk drive (HDD) of the DVR to store the multi-channel sub-image signals from the CPU 32.

The image adjustment unit 40 receives the digital signals from the detection device 14 to adjust the lens module 12 in real time, allowing surveillance or monitoring from different angles. The image adjustment unit 40 includes an image encoding module 42 and an image output module 44 electrically connected to the image encoding module 42.

The image encoding module 42 is electrically connected to the detection device 14, and is capable of receiving panoramic images from the detection device 14 in the form of digital signals and encoding the digital signals, and then transmitting the encoded digital signals to the image display module 44 through a high definition multimedia interface (HDMI). The image output module 44 can be a liquid crystal display (LCD) touch screen and is usable of displaying the panoramic images, providing touch-enabled adjustment of the lens module 12 and automatically adjust the focal length of the lens module 12 for surveillance and monitoring from different angles.

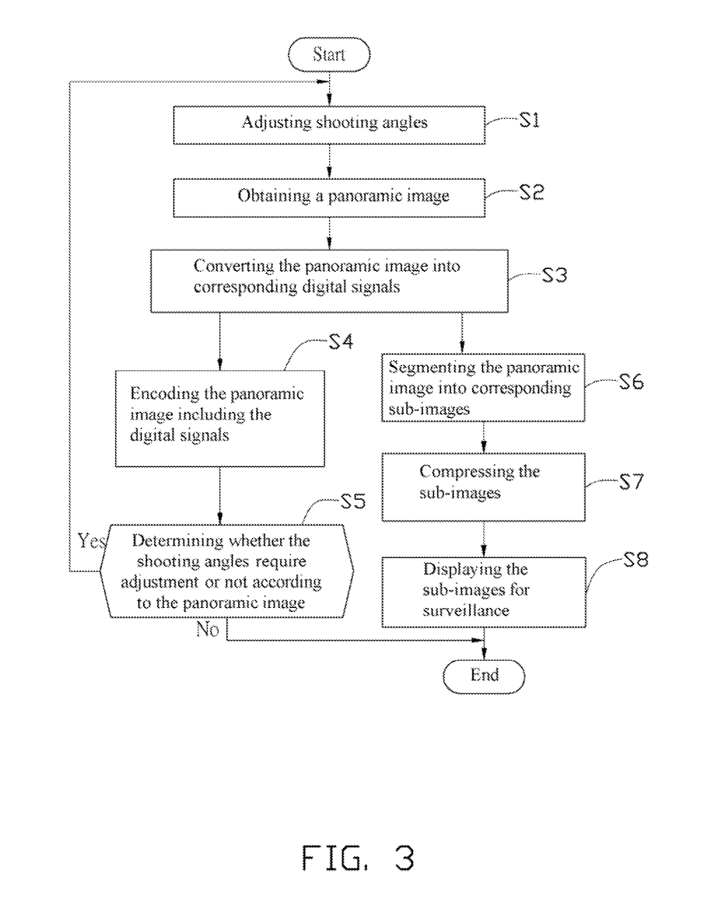

Further referring to FIG. 3, an image segmentation method according to an exemplary embodiment is depicted. The image segmentation method can use the aforementioned image segmentation system 100 and may at least include the following steps.

In step S1, shooting angles of the lens module 12 are adjusted for real-time surveillance and monitoring from different angles.

In step S2, different panoramic images (e.g., circular panoramic images) are obtained and provided by the lens module 12 for the detection device 14.

In step S3, the panoramic images from the lens module 12 are converted into corresponding digital signals by the detection device 14, when the digital signals are transmitted to the image encoding module 42, step S4 is implemented; when the digital signals are transmitted to the DSP 22, step S6 is implemented.

In step S4, the panoramic images including digital signals from the detection device 14 are processed and encoded by the image encoding module 42.

In step S5, the processed panoramic images from the image encoding module 42 are output and displayed on the image output module 44 to determine whether the shooting angles of the lens module 12 require adjustment or not according to the encoded digital signals. If adjustment is required, step S1 is repeated.

In step S6, the panoramic images including digital signals from the detection device 14 are segmented by the DSP 22 into multi-channel sub-image signals, and the sub-image signals are transmitted to the SOC 24.

In step S7, the sub-images from the DSP 22 are compressed by the SOC 24 to be transmitted to the CPU 32.

In step S8, the compressed sub-images from the SOC 24 are stored in the storage module 24 or displayed on the display module 36 for surveillance under the control of the CPU 32.

The detection device 14 in this exemplary embodiment is not limited to the CMOS sensor, but may be a charge coupled device (CCD) sensor or other image sensors.

Moreover, according to different specific conditions of the monitored target areas and the different pixel of the IP camera, the DSP 22 can adjustably segment the panoramic images into two-channel sub-images, four-channel sub-images or eight-channel sub-images, thereby reducing the number of CCTV cameras.

In summary, in the image segmentation system 100 of the exemplary embodiment, the lens module 12 captures and obtains 360° panoramic images, and the DSP 22 built-in the IP camera then segments, expands, corrects the panoramic images to divide the panoramic images into a number of sub-images to monitor different areas. Thus, in the image segmentation system 100, an IP camera can capture and obtain multi-channel monitoring images and has broader shooting scope, as to replace a number of CCTV cameras, which can reduce design and maintenance coasts.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. An image segmentation system, comprising:
an image recording unit for capturing and obtaining a panoramic image of a target area;
an image processing unit electrically connected to the image recording unit, the image processing unit to divide the panoramic image from the image recording unit into corresponding sub-images, and compress the sub-images; and
an image monitoring unit electrically connected to the image processing unit, wherein the image monitoring unit stores the compressed sub-images from the image processing unit, and displays the sub-images.

2. The image segmentation system as claimed in claim 1, wherein the image recording unit comprises a lens module that captures and obtains the panoramic image.

3. The image segmentation system as claimed in claim 2, wherein the image recording unit comprises a detection device electrically connected to the lens module, the detection device capable of receiving the panoramic image from the lens module and converting the received panoramic image into corresponding digital signals.

4. The image segmentation system as claimed in claim 3, wherein the image processing unit comprises a digital signal processor electrically connected to the detection device, the digital signal processor capable of segmenting, expanding, and correcting the digital signals to divide the panoramic image into the corresponding sub-images.

5. The image segmentation system as claimed in claim 4, wherein the image processing unit further comprises a system on chip electrically connected to the digital signal processor, the system on chip capable of receiving and compressing the sub-images to reduce redundant data and improve transmission speed.

6. The image segmentation system as claimed in claim 5, wherein the image monitoring unit comprises a CPU that is electrically connected to the system on chip to receive the compressed sub-images.

7. The image segmentation system as claimed in claim 6, wherein the image monitoring unit further comprises a storage module electrically connected to the CPU, the storage module capable of storing the compressed sub-images under the control of the CPU.

8. The image segmentation system as claimed in claim 6, wherein the image monitoring unit further comprises a display module electrically connected to the CPU, the display module capable of displaying the compressed sub-images under the control of the CPU.

9. The image segmentation system as claimed in claim 8, wherein the storage module is a hard disk drive.

10. The image segmentation system as claimed in claim 3, wherein the detection device is complementary metal oxide semiconductor sensor or a charge coupled device sensor.

11. The image segmentation system as claimed in claim 3, further comprising an image adjustment unit, wherein the image adjustment unit receives the digital signals from the detection device to adjust the lens module in real time to allow the lens module for monitoring or surveillance of the target area.

12. The image segmentation system as claimed in claim 11, wherein the image adjustment unit comprises an image encoding module electrically connected to the detection device, the image encoding module capable of receiving the panoramic image from the detection device and encoding the digital signals.

13. The image segmentation system as claimed in claim 12, wherein the image adjustment unit further comprises an image output module electrically connected to the image encoding module, the image output module capable of displaying the panoramic image to provide adjustment of the lens module in different directions and adjust focal length of the lens module.

14. An image segmentation method, comprising:
obtaining a panoramic image of a target area by an image recording unit;
segmenting the panoramic image from the image recording unit into corresponding sub-images by an image processing unit;
compressing the sub-images by a system on chip of the image processing unit; and
storing and displaying the sub-images by an image monitoring unit for surveillance.

15. The image segmentation method as claimed in claim 14, further comprising adjusting shooting angles of a lens module in the image recording unit for real-time surveillance and monitoring of the target area from different angles.

16. The image segmentation method as claimed in claim 15, further comprising converting the panoramic image from the image recording unit into corresponding digital signals by a detection device of the image recording unit.

17. The image segmentation method as claimed in claim 16 further comprising encoding and displaying the panoramic image including the digital signals from the detection device.

18. The image segmentation method as claimed in claim 17, further comprising determining whether the shooting angles of the lens module require adjustment, if the adjustment is required, the step of adjusting shooting angles of a lens module is repeated.
